(19) United States
(12) Patent Application Publication
(10) Pub. No.: US 2010/0159220 A1
(43) Pub. Date: Jun. 24, 2010

(54) METHOD AND APPARATUS FOR MANUFACTURING ARTICLES IN THE FORM OF SLABS OR TILES WITH CHROMATIC EFFECTS SUCH AS VEINING AND/OR SPOTTED EFFECTS

(76) Inventor: Luca Toncelli, Bassano del Grappa (IT)

Correspondence Address: KATTEN MUCHIN ROSENMAN LLP, 575 MADISON AVENUE, NEW YORK, NY, 10022-2585, US

(21) Appl. No.: 12/160,535

(22) PCT Filed: Dec. 29, 2006
(86) PCT No.: PCT/EP2006/070270

§ 371 Date: Sep. 11, 2008

(30) Foreign Application Priority Data
Jan. 10, 2006 (IT) TV2006A000003

(51) Int. Cl. B32B 13/00; B28B 1/087

(52) U.S. Cl. 428/210; 264/69

(57) ABSTRACT

During the manufacture of thin flat articles, in particular slabs and tiles using Terastone™ technology, special chromatic effects, in particular veined and spotted effects, are obtained by staining the production mould, prior to deposition of the starting mix, with one or more coloured cement pastes which are randomly deposited in the form of drops.

The present invention relates to the manufacture of thin articles, in particular slabs and tiles, which are made of stone or stone-like conglomerate material mixed with a hydraulic binder and have special chromatic effects.

During recent years a technology (technically and commercially known as Terastone™) has been developed on an industrial level; this technology is described, for example, in the patent IT-A-1 288 569 and in the corresponding patents EP-A-0 817 709 and U.S. Pat. No. 6,355,191. The contents of said patents are fully referred to in the present patent.

According to this technology, a starting mix is prepared, said mix consisting of one or more granulated stone or stone-like materials, a cement binder and specific additives known in the sector of cement articles. Then, this mix is distributed in the form of a thin layer inside a mould.

The mould is subsequently transferred to a deaeration and compaction station where, in one or more passes and under vacuum, it is subjected to a vibratory movement of predetermined frequency.

The resultant rough-formed article is left to harden inside the mould for about 24 hours and is then extracted and left to cure for a time of about one week. At the end, the usual finishing operations (for example sizing and polishing) of the article are performed. If it is required that the article reproduces the appearance of natural stone materials, which usually have differently coloured veined or spotted zones, hitherto it has been necessary to use simply mixtures of granulated materials with different colours.

However, the effect obtained is dot-like in form, namely is limited to the single granule, so that from an aesthetic point of view it has not been possible hitherto to obtain special chromatic effects and in particular effects where there the colour is diffused, particularly in form of veins and spots, like the articles made of natural stone.

On the other hand, hitherto it has been possible to act solely on the type of granulated material and not on other features of the process and/or of the manufacturing plant. In fact, in view of the rheology of the mix which is particularly fluid since it contains water, the aggregation of differently coloured mixes is not feasible, while it is feasible in the case of organic binders, avoiding that the various pigments are thoroughly mixed, and consequent it is impossible to achieve the desired polychromatic effects.

The present invention aims at solving this problem in an industrially advantageous manner so as to obtain articles in the form of thin slabs or tiles, with special chromatic effects, in particular the already mentioned veins and spots.

This aim is achieved by a method which, in the context of the abovementioned process of manufacturing articles using so-called Terastone™ technology, envisages, prior to the deposition of the starting mix, a random deposition on the bottom of the mould of irregular droplets of a cementitious colouring paste which is somewhat dense but fairly fluid, consisting substantially of white cement, water, an optional fluidizer and one or more colouring agents in a mixture, the bottom inner surface of the mould being suitably treated beforehand with a separating agent. The subsequent steps of the Terastone™ technology take place in a conventional manner.

It has been experimentally ascertained that, during the vacuum vibrocompaction step, owing to the vibration and the rheological characteristics of the starting mix in the Terastone™ method, each droplet of colouring paste present on the bottom of the mould is subject to local diffusion into the overlying layer of mix and is suitable to merge with some adjacent droplets.

In some circumstances the localized diffusion of the droplet of colouring paste may affect the entire thickness of the layer of mix, thus becoming visible also on the opposite surface.

This localized diffusion effect is particularly important because it allows the desired chromatic effect, with a spotted and veined appearance, to be achieved on the visible surface of the finished slab, as mentioned above.

As regards the apparatus, the present invention consists in the installation—in a plant for the production of articles consisting of slabs or tiles using Terastone™ technology—of a device able to distribute in the form of droplets one or more cementitious colouring pastes, said device comprising at least one tank for feeding a cementitious colouring paste and at least one nozzle connected to said at least one supply tank by means a pumping system.

The nozzle is in turn provided with actuating means and consequently for delivering said colouring paste, the said means comprising an automatic regulating valve for intermittently spraying large drops of colouring paste, in a random layout.

Preferably, the construction of the apparatus is in the form of a bridge structure comprising two uprights and a central cross-piece with which one series, and preferably several series, of spray nozzles are associated, said nozzles being supplied through a pump by a respective container containing a colouring paste which is kept stirred by means of a suitable stirrer.

In the case of a plurality of nozzles or series of nozzles and a corresponding plurality of containers, each container or at least part of the containers feeds a different colouring paste.

Each nozzle is provided with a closing valve which is controlled preferably electronically and regulates the through-flow so that, whenever the valve opens, colouring paste in the form of large irregular drops is sprayed from the corresponding nozzle.

The trays or moulds are displaced so that they pass underneath the cross-piece of the bridge structure and during this displacement the colouring paste is sprayed.

Since the trays or moulds may have different dimensions it is possible and envisaged adjusting the position of the nozzles or some of them along the said cross-piece, manually or by means of motor means, so as to ensure adaptation to the size of the mould to be treated and prevent the wastage of colouring paste as well as the contamination of the conveyor and the working environment.

Distribution of the colouring paste on the bottom of the mould may be varied as required, by varying the opening and closing cycle of the nozzles as well as their position and height over the bottom of the trays or moulds.

After passing underneath the spraying apparatus, the inner surface of the bottom of the mould or tray is stained in an irregular manner by more or less large coloured drops having a dimension of preferably 1 mm² to 1 cm², depending on how much each of the nozzles is open.

Obviously the control valves of the nozzles are closed during the times needed for replacement of an already sprayed mould with the next mould to be sprayed, avoiding also in this case a wastage of colouring paste and a contamination of the apparatus and of the working environment.

Other solutions than the use of spray nozzles are possible for obtaining a distribution of colouring paste in the form of drops, such as sprinkling devices, provided that the desired effect is achieved, namely the deposition, on the bottom of the mould or tray, of drops of colouring paste having a dimension of a few millimetres, the drops being spaced from each other and distributed randomly or in any case giving the visual aspect of a random distribution.

Returning to the method according to the invention, the colouring paste is a fairly fluid thixotropic mix essentially composed, as already mentioned, of cement, water and a colouring agent or pigment. A suitable composition, with a volumetric ratio water to cement of 50/50, may be:

| | | |
|---|---|---|
| white Portland cement, as binder | 3,150 | g (namely 1 litre) |
| water | 1,000 | g (namely 1 litre) |
| fluidizer | 31 | g |
| colouring agent (e.g. metal oxides) | 60 | g |

Thus, a fluid but fairly dense mixture with a specific weight of about 2 kg/dm³ is obtained.

Other compositions are possible, as well as different ingredients can be utilized, provided that the colouring paste is in any case compatible with the starting mix which is subsequently poured into the mould or tray. In any case, the binder used to obtain the colouring paste must necessarily be of the cementitious type.

The quantity of colouring paste used for a tray having a size of 40×40 cm may vary for example from a minimum of 10 g to a maximum of 50 g.

The accompanying drawings show a non-limiting example of embodiment of an apparatus according to the invention:

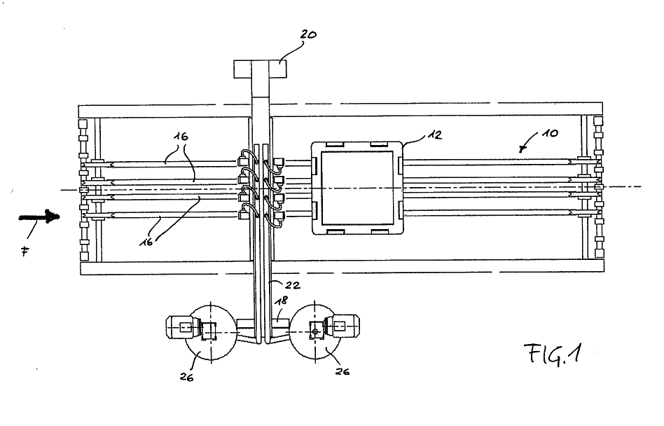

FIG. 1 is a top view of the apparatus;

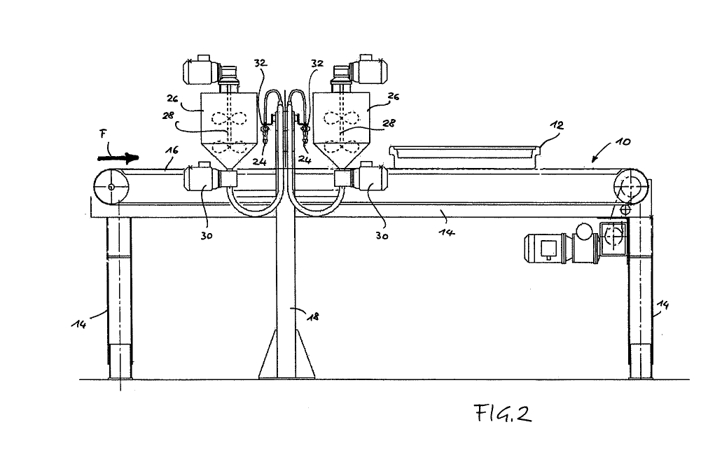

FIG. 2 is a side view of the apparatus according to FIG. 1; and

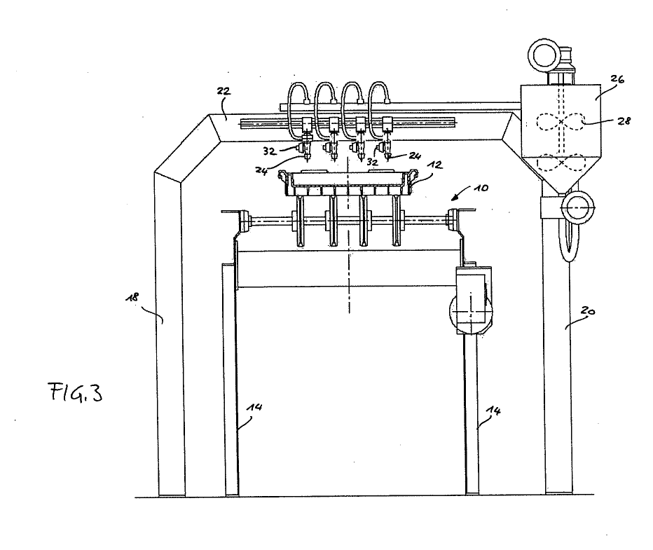

FIG. 3 is a corresponding front view.

With reference to the drawings, the apparatus comprises a bench 10 for displacement and transportation of tray moulds 12 of the known type and used in Terastone™ technology.

The bench 10 consists of a frame 14 supporting a plurality of conveyor belts 16 on which the trays or moulds rest and are fed intermittently in the direction of the arrows F in FIGS. 1 and 2.

A gantry structure comprising two uprights 18 and 20 connected by a cross-piece 22 is arranged astride the belts 16.

A plurality of nozzles 24 are adjustably fixed to the cross-piece 22, preferably arranged in several rows of one or more nozzles, each nozzle being connected to a container 26 provided with a motor-driven stirrer, through a pump 30 and a regulating valve 32 which is opened and closed preferably by means of an electronic control system.

Downstream of the above described apparatus, the trays or moulds 12 are inserted along a conventional line for the production of slabs or tiles according to the Terastone™ technology, which in this case means that each tray is arranged underneath the dispenser for charging of the starting mix, comprising granulated material, cementitious binder and additives, and then conveyed to the stations for vacuum vibrocompaction and subsequent curing of the mix.

From the tests carried out it has been possible to establish that, according to the present invention, slabs with the desired chromatic effects are obtainable.

Within the scope of the following claims, the method and the apparatus according to the present invention may be subject to conceptually equivalent modifications and variants which may occur to a person skilled in the art.

1.-11. (canceled)

12. Method for manufacturing thin flat articles, in particular slabs and tiles, of the type in which a starting mix is prepared, said mix comprising one or more granulated products consisting of stone or stone-like material and a cement binder, as well as specific additives which are conventional in the field of cement products, the method comprising the steps of:
a) pouring the mix in the form of a thin layer into a tray mould (12);
b) transferring the mould to a deaeration and compaction station where, in at least one pass and under a vacuum, the starting mix is subjected to a vibratory movement of predetermined frequency;
c) hardening the resultant rough-formed article inside the tray mould (12) for about 24 hours;
d) removing the article from the mould (12);
e) curing the article for a time of about one week,
characterized in that, prior to pouring of the said starting mix, a plurality of drops of at least one colouring paste composed essentially of cement, water, an optional fluidizer and at least one colouring agent or pigment are deposited on the inner surface of the bottom of the mould (12).

13. Method for manufacturing thin flat articles according to claim 12, characterized in that said drops are of various differently coloured colouring pastes.

14. Method for manufacturing thin flat articles according to claim 12, characterized in that said drops of colouring paste have a diameter of 1 mm² to 1 cm².

15. Method for manufacturing thin flat articles according to claim 14, characterized in that said drops are deposited so as to be randomly distributed or in any case giving the visual aspect of a random distribution.

16. Method for manufacturing thin flat articles according to claim 12, characterized in that said colouring paste is fluid and has a density of about 2 kg/dm³.

17. Method for manufacturing thin flat articles according to claim 12, characterized in that said mould (12) is treated with a separating agent before deposition of the drops of colouring paste.

18. Thin flat article, in the form of a slab or tile, having veining and/or spotted effects, obtainable with the method according to claim 12.

19. Thin flat article, in the form of a slab or tile, having veining and/or spotted effects, obtainable with method according to claim 13.

20. Thin flat article, in the form of a slab or tile, having veining and/or spotted effects, obtainable with the method according to claim 14.

21. Thin flat article, in the form of a slab or tile, having veining and/or spotted effects, obtainable with the method according to claim 15.

22. Thin flat article, in the form of a slab or tile, having veining and/or spotted effects, obtainable with the method according to claim 16.

23. Thin flat article, in the form of a slab or tile, having veining and/or spotted effects, obtainable with the method according to claim 17.
